(19) United States
(12) Patent Application Publication
(10) Pub. No.: US 2006/0202915 A1
(43) Pub. Date: Sep. 14, 2006

(54) Light emitting apparatus generating white light by mixing of light of a plurality of oscillation wavelengths

(75) Inventor: Hiroshi Chikugawa, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/371,898

(22) Filed: Mar. 8, 2006

(30) Foreign Application Priority Data
Mar. 8, 2005 (JP) 2005-064249

(51) Int. Cl. G09G 3/14

(52) U.S. Cl. 345/46

(57) ABSTRACT

A first light emitting diode and a second light emitting diode are connected in parallel between a first node and a second node. The two light emitting diodes are connected to each other in such a manner that, an anode of each one light emitting diode is electrically connected to a cathode of the other light emitting diode. As a driving portion applies an AC voltage to each of the two light emitting diodes, a light emitting apparatus can alternately emit light of two colors (blue and green) and light of one color (red). Therefore, since white light can be generated with one driving circuit, size and cost reductions of a light emitting apparatus can be attained. As a result, a light emitting apparatus which is small and capable of easy adjustment of chromaticity can be provided.

This nonprovisional application is based on Japanese Patent Application No. 2005-064249 filed with the Japan Patent Office on Mar. 8, 2005, the entire contents of which are hereby incorporated by reference.

### BACKGROUND OF THE INVENTION

1. Field of the Invention

The present invention relates to a light emitting apparatus and, more specifically, to a light emitting apparatus generating white light by mixing of light of a plurality of oscillation wavelengths.

2. Description of the Background Art

Studies have been made to develop a white light source of high quality using a light emitting diode (also referred to as an LED). The white light source using a light emitting diode is utilized in, for example, a backlight of a liquid crystal display apparatus, a luminaire or an image reading apparatus.

Methods of generating a white light source with a light emitting diode are broadly divided into a method using a fluorescent material and a method using a plurality of oscillation wavelengths. In the method using a fluorescent material, a fluorescent material is used for converting light ranging from ultraviolet to blue emitted from the light emitting diode into colors such as yellow, green and red to generate a white color. In the method using a plurality of oscillation wavelengths, a plurality of light emitting diodes having two, three or more different oscillation wavelengths are turned on to generate a white color.

With either method, however, it is difficult to actually obtain desired chromaticity and intensity of emitted light.

In the former method using the fluorescent material, brightness of the ultraviolet-to-blue light emitting diode varies and chromaticity largely differs due to variation in application of the fluorescent material. Furthermore, once the white light source using the fluorescent material is manufactured as a product, adjustment of the chromaticity becomes substantially impossible.

As to the latter method using a plurality of oscillation wavelengths, various techniques have been conventionally proposed. Japanese Patent Laying-Open No. 2001-144332, for example, discloses a method of driving an LED, an LED apparatus, an LED lamp, a method of driving an LED lamp, and a display apparatus in which, in an LED device emitting light having a color changed with a driving current value, a current value of a pulse current for driving an LED device is set corresponding to a wavelength of emitted light or a duty of the pulse current is set corresponding to intensity of emitted light so as not to change a color of emitted light when intensity of light is varied.

Japanese Patent Laying-Open No. 2004-086081 discloses a color display apparatus including a time memory circuit for storing a time of light emission of a plurality of light emitting diodes and a control unit for varying the time of light emission of the light emitting diodes based on stored information of the time memory circuit, in which a white balance of light obtained by light emission of a plurality of light emitting devices is adjusted by rewriting the stored information of the time memory circuit.

As described above, in a conventional technique, an amount of a flowing current, that is, intensity of emitted light is varied for each light emitting device to generate desired chromaticity, and a pulse width or a duty ratio of a driving voltage is varied to adjust intensity of emitted light. This is because, in a common light emitting diode, an oscillation wavelength varies when an amount of a current flowing therethrough varies, and consequently chromaticity varies. Therefore, once the chromaticity is determined, generally a current value will not be varied and, alternatively, a lighting time is varied to vary brightness of the light emitting device.

Particularly, in the method of driving an LED disclosed in the aforementioned Japanese Patent Laying-Open No. 2001-144332, a current value is positively varied to cause a blue shift of a color of light emitted from the LED to efficiently generate fluorescent light from a fluorescent body. This method of driving an LED, however, is not a method for adjusting chromaticity by combining with another light emitting diode.

Adjustment of chromaticity alone without that of intensity of emitted light can be performed by varying a ratio of a lighting time of a light emitting diode of each oscillation wavelength.

When a plurality of white light sources are aligned to be used as a backlight of a liquid crystal display or a light source for illumination, even a small difference in chromaticity among the white light sources will give an unnatural impression because human eyes feel a difference in colors large by comparison. Therefore, chromaticity of the white light sources have to be made as even as possible.

In the conventional method of generating the white light source using a plurality of oscillation wavelengths, since a current flowing through each light emitting device is controlled independently, independent adjustment functions of the same number as that of light emitting devices or oscillation wavelengths are required. Therefore, a whole driving circuit becomes large and complicated, which results in an increased cost. In addition, since adjustment of chromaticity is required for each oscillation wavelength, an adjustment operation becomes complicated.

### SUMMARY OF THE INVENTION

An object of the present invention is to provide a light emitting apparatus which is small and capable of easy adjustment of chromaticity.

In summary, the present invention is a light emitting apparatus generating white light by mixing a plurality of light, which includes a first light emitting device portion, a second light emitting device portion and a driving portion. The first light emitting device portion emits first light having first and second oscillation peak wavelengths corresponding to a first driving current. The second light emitting device portion emits second light having a third oscillation peak wavelength and having a complementary color of a color of the first light corresponding to a second driving current different from the first driving current. The driving portion supplies the first and second driving currents to the first and second light emitting device portions, respectively.

Preferably, the driving portion alternately outputs the first driving current and the second driving current.

More preferably, when a value of the first driving current varies, a variation in the second oscillation peak wavelength is larger than that in the first oscillation peak wavelength.

Further preferably, the first oscillation peak wavelength is within a range of blue light. The second oscillation peak wavelength is within a range of green light. The third oscillation peak wavelength is within a range of red light.

Further preferably, each of the first and second light emitting device portions is a light emitting diode connected in parallel between first and second nodes so as to have an electrical polarity opposite to each other. The driving portion applies an AC current having periodically changing polarities between the first and second nodes.

Further preferably, each of the first driving current and the second driving current has a waveform of a rectangular wave.

Further preferably, each of a period for flowing the first driving current and a period for flowing the second driving current is determined corresponding to chromaticity of the white light.

Further preferably, the AC current has a frequency from 30 Hz to 100 kHz.

Preferably, the driving portion outputs a pulse current as the first driving current and outputs a constant current as the second driving current.

More preferably, when a value of the pulse current varies, a variation in the second oscillation peak wavelength is larger than that in the first oscillation peak wavelength.

Further preferably, the first oscillation peak wavelength is within a range of blue light. The second oscillation peak wavelength is within a range of green light. The third oscillation peak wavelength is within a range of red light.

Therefore, a main advantage of the present invention is that a control circuit for controlling a driving current is not required to be provided for each of a plurality of light emitting devices, which enables size and cost reductions of a light emitting apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a circuit construction of a light emitting apparatus according to a first embodiment.

FIG. 2 schematically shows an example of a device structure of a light emitting diode 12 shown in FIG. 1.

FIG. 3 is a diagram for describing variations with time in currents If1 and If2 shown in FIG. 1.

FIG. 4 shows a circuit construction of a light emitting apparatus according to a second embodiment.

FIG. 5 is a diagram for describing variations with time in currents If1 and If2 shown in FIG. 4.

FIG. 6 shows a circuit construction of a light emitting apparatus according to a third embodiment.

FIG. 7 is a diagram for describing variations with time in currents If1 and If2 shown in FIG. 6.

### DESCRIPTION OF THE PREFERRED EMBODIMENTS

Embodiments of the present invention will now be described in detail referring to the drawings. It is to be noted that, the same or corresponding portions in the drawings are indicated with the same characters and descriptions thereof will not be repeated.

### First Embodiment

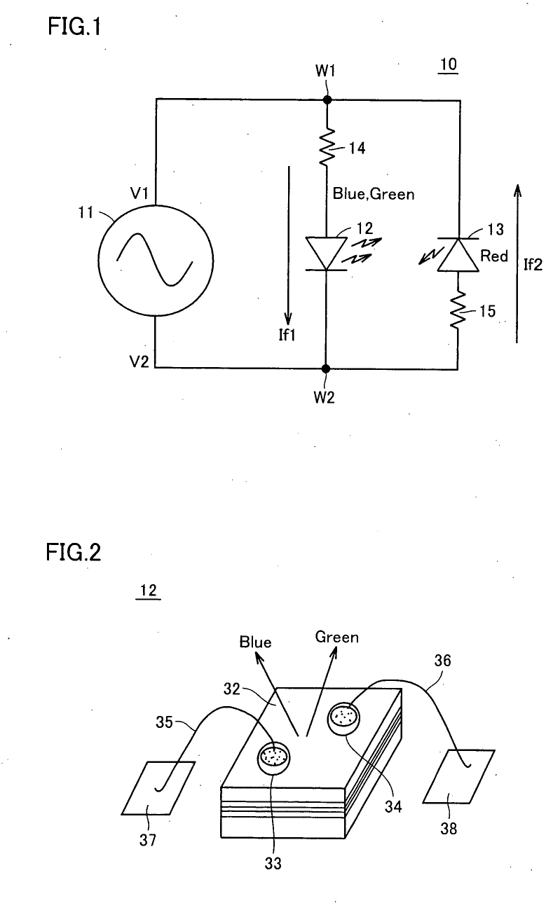

FIG. 1 shows a circuit construction of a light emitting apparatus according to a first embodiment. Referring to FIG. 1, a light emitting apparatus 10 generates white light by mixing light of three colors, that is, blue, green and red. Light emitting apparatus 10 includes a driving portion 11, light emitting diodes 12, 13 and resistances 14, 15.

Driving portion 11 is connected between a node W1 and a node W2, and outputs an AC voltage. A current If1 flowing from node W1 to node W2 is a positive-polarity current, and a current If2 flowing from node W2 to node W1 is a negative-polarity current.

Light emitting diode 12 has an oscillation peak wavelength of a blue color and an oscillation peak wavelength of a green color, and emits mixed light of blue and green light corresponding to current If1 which is a first driving current. Light emitting diode 12 includes one light emitting device (an LED chip) emitting blue and green light.

As current If1 increases, both of the oscillation peak wavelengths of green and blue colors vary from a long wavelength side to a short wavelength side. A variation in the oscillation peak wavelength of the green color for a variation in a value of a current amount is larger than that in the oscillation peak wavelength of the blue color. As the current amount increases, the oscillation peak wavelength of the green color having a large wavelength variation varies from the long wavelength side to the short wavelength side, and thereby chromaticity of mixed light formed by mixing of blue and green light varies.

As described above, since one light emitting device emitting light having a plurality of different oscillation peak wavelengths is included in the light emitting apparatus, a number of circuits for driving the light emitting device can be decreased and therefore light emitting apparatus 10 can be made smaller.

In light emitting diode 12, the light having a wavelength variation larger than that of blue light is not necessarily limited to green light, and it may be, for example, yellow-green, yellow or orange light.

Light emitting diode 13 has a third oscillation peak wavelength and emits light of a red color, which is a complementary color of a color of the mixed light of blue and green light, corresponding to current If2 which is a second driving current. Though a combination of blue and green light can provide white light which is sufficient in a practical aspect, a resulting white color becomes somewhat bluish because of lack of red light as one of the primary colors of light. Emission of red light from light emitting diode 13 has an effect of extending a range of an adjustment of chromaticity.

Resistance 14 and resistance 15 are respectively provided to determine values of currents If1, If2. Each of resistances 14, 15 is a fixed resistance. A resistance value of the fixed resistance is set as appropriate to obtain white light of desired chromaticity. It is to be noted that, at least one of resistances 14, 15 may be a variable resistance. In this situation, chromaticity, luminous intensity or the like can be adjusted even after assembly of light emitting apparatus 10 by varying a resistance value of the variable resistance.

Light emitting diode 12 and light emitting diode 13 are connected in parallel between node W1 and node W2. The two light emitting diodes are connected to each other in such a manner that, an anode of each one light emitting diode is electrically connected to a cathode of the other light emitting diode. As driving portion 11 applies an AC current to each of light emitting diodes 12, 13, light emitting apparatus 10 can alternately emit light of two colors (blue and green) and light of one color (red). Since white light can be generated with one driving circuit, size and cost reductions of the light emitting apparatus can be attained.

FIG. 2 schematically shows an example of a device structure of light emitting diode 12 shown in FIG. 1. Referring to FIG. 2, light emitting diode 12 includes a light emitting diode chip 32, wires 35, 36, and external electrodes 37, 38. Wires 35, 36 are made of, for example, Au (gold). Light emitting diode chip 32 has a semiconductor multilayer structure and includes internal electrodes 33, 34. With application of voltages from external electrodes 37, 38 to internal electrodes 33, 34 via wires 35, 36, respectively, light emitting diode chip 32 emits light of a plurality of different wavelengths corresponding to blue and green colors which are mixed to generate white light.

In light emitting diode chip 32, a ratio of a variation in an energy level associated with light emission can be varied in each of a portion for emitting blue light and a portion for emitting green light by changing a material used or a ratio of the material. Therefore, variations in oscillation peak wavelengths corresponding to blue and green colors for a variation in a current amount can be made different from each other.

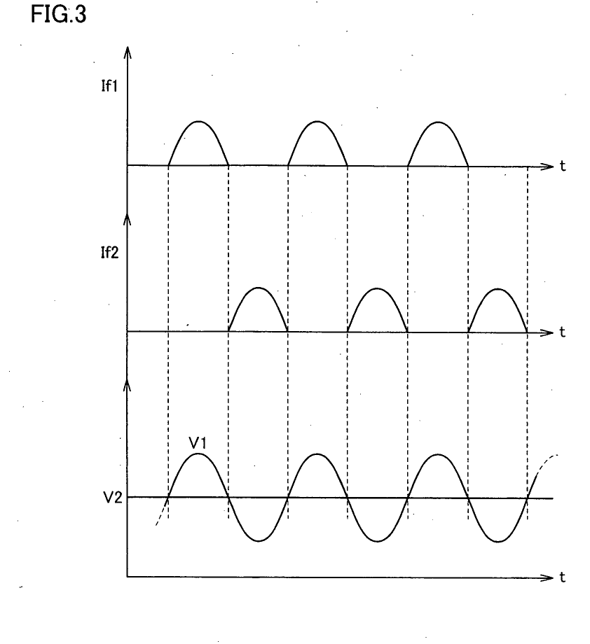

FIG. 3 is a diagram for describing variations with time in currents If1 and If2 shown in FIG. 1. Referring to FIG. 3, variations with time in currents If1 and 1f2 as well as a potential V1 are shown with reference to a state in which a current is not flowing from driving portion 11. Since potential V1 has a waveform of a sine wave, a waveform of each of currents If1 and If2 corresponds to a waveform of a half period of the sine wave. Therefore, since currents If1 and If2 alternately flow, light emitting diodes 12 and 13 are alternately lighted.

Potential V1 preferably has a frequency from 30 Hz to 100 kHz. When the frequency is lower than 30 Hz, flicker is felt by human eyes. When the frequency is higher than 100 kHz, a response characteristic of the light emitting diode is degraded and a circuit becomes complicated. A more preferable range of the frequency of potential V1 is 1-20 kHz.

Referring back to FIG. 1, a method of adjusting and determining chromaticity in light emitting apparatus 10 is described. First, a prescribed current is allowed to flow through each of light emitting diodes 12, 13 to measure luminous intensity and chromaticity. Alternatively, luminous intensity and chromaticity are measured while varying a current flowing through each of light emitting diodes 12, 13. Then, values of currents If1 and If2 required to obtain desired luminous intensity or chromaticity are determined based on a result of measurement. A resistance value of each of resistances 14, 15 is determined based on a determined current value. It is to be noted that, adjustment or determination of chromaticity is performed at a designing or prototyping stage of light emitting apparatus 10, and fixed resistances are used as resistances 14, 15 in finished goods.

Chromaticity can also be adjusted by varying a peak value of potential V1 to vary an amount of a current flowing through each of light emitting diodes 12, 13. Adjustment of chromaticity for generating desired white light, however, becomes difficult because a forward current flowing through each of light emitting diodes 12, 13 varies uniformly. Chromaticity is generally indicated as values of X and Y coordinates (chromaticity coordinates) on a chromaticity diagram according to a calorimetric system defined by CIE (Commission Internationale de l'Eclairage: International Commission on Illumination). With varying the peak value of potential V1, X and Y coordinates cannot be separately varied for adjustment. With varying the peak value of potential V1, however, colors can be readily switched, for example, between a white color and a color of electric lamp.

In addition, since chromaticity is determined with a ratio of an amount of light of each wavelength, intensity of emitted light can be varied by varying luminous intensity of each light emitting diode with maintaining the ratio of the amount of light.

As described above, in the light emitting apparatus of the present invention, chromaticity is not adjusted by varying oscillation intensity at each wavelength as in a conventional technique, but is adjusted to desired chromaticity by positively utilizing the wavelength variation in light emitting diode 12 according to current If1.

According to the first embodiment as described above, since the driving circuit outputting an AC voltage alternately drives the light emitting diodes respectively emitting light of two colors and light of one color, white light can be emitted with one driving circuit. Therefore, size and cost reductions of the light emitting apparatus can be attained.

### Second Embodiment

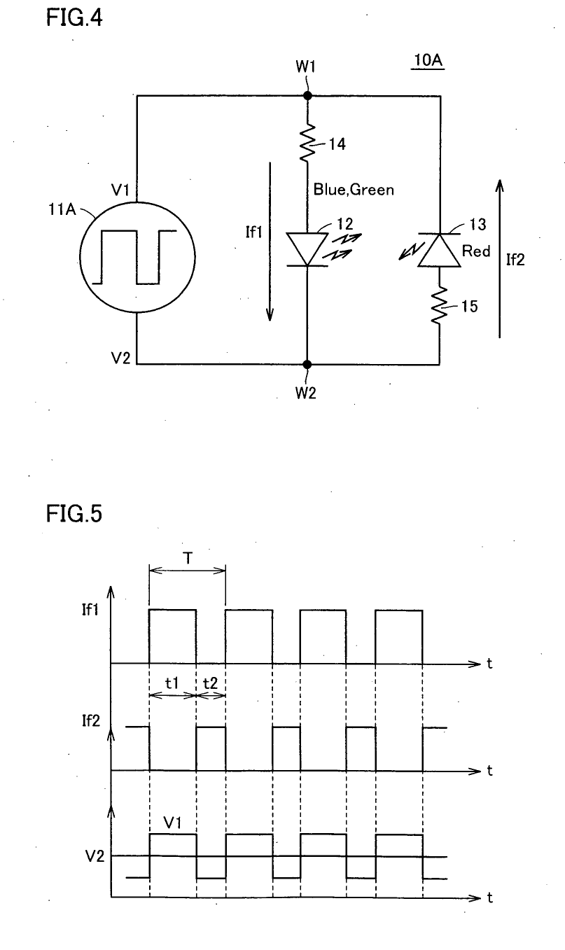

FIG. 4 shows a circuit construction of a light emitting apparatus according to a second embodiment. Referring to FIG. 4, a light emitting apparatus 10A is different from light emitting apparatus 10 shown in FIG. 1 in that a driving portion 11A is included in place of driving portion 11. Since constructions of the other portions of light emitting apparatus 10A are similar to those of corresponding portions of light emitting apparatus 10, descriptions thereof will not be repeated.

Driving portion 11A outputs an AC voltage having a waveform of a rectangular wave, which is different from driving portion 11. As shown in FIG. 3, in the first embodiment, a value of each of currents If1, If2 varies during a period of outputting each of currents If1, If2. Thus, luminous intensity of each of light emitting diodes 12, 13 varies during a lighting period thereof In the second embodiment, since each of currents If1, I2 has a waveform of a rectangular wave, luminous intensity of each of light emitting diodes 12, 13 is constant during the lighting period. Therefore, flicker can be decreased even when a lighting frequency is low.

FIG. 5 is a diagram for describing variations with time in currents If1 and If2 shown in FIG. 4. Referring to FIG. 5, since potential V1 is a rectangular wave, each of currents If1, If2 also has a waveform of a rectangular wave. A time t1 represents a time for flowing current If1, a time t2 represents a time for flowing current If2, and a time T represents a sum of time t1 and time t2. A duty ratio of current If1 is expressed as t1/T and a duty ratio of current If2 is expressed as t2/T (=1−t1/T).

An average value of the current flowing through each of light emitting diodes 12, 13 is varied by varying duty ratios t1/T and t2/T. Chromaticity of light emitted from the light emitting diode varies corresponding to a variation in the average value of the current. Therefore, chromaticity is adjusted by varying the duty ratios t1/T and t2/T to obtain desired white light.

It is to be noted that, as in the first embodiment, potential V1 preferably has a frequency from 30 Hz to 100 kHz. In particular, when the frequency is higher than 100 kHz, a response characteristic of the light emitting diode is degraded and rounding of the waveform occurs for the current flowing through the light emitting diode.

According to the second embodiment as described above, since the driving circuit outputting the AC voltage of the rectangular wave alternately drives the light emitting diodes respectively emitting light of two colors and light of one color, size and cost reductions of the light emitting apparatus can be attained and flicker can be decreased.

### Third Embodiment

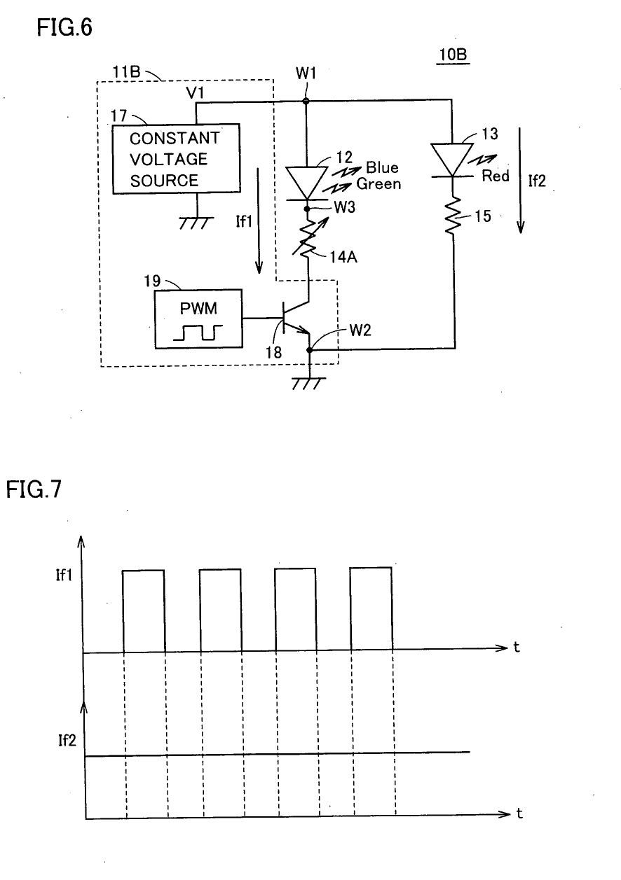

FIG. 6 shows a circuit construction of a light emitting apparatus according to a third embodiment. Referring to FIG. 6, a light emitting apparatus 10B is different from light emitting apparatus 10 shown in FIG. 1 in that a driving portion 11B is included in place of driving portion 1 1. Light emitting apparatus 10B is also different from light emitting apparatus 10 in that a resistance 14A which is a variable resistance is included in place of resistance 14 which is a fixed resistance.

Driving portion 11B includes a constant voltage source 17, an NPN transistor 18 and a PWM (Pulse Width Modulation) circuit 19. Constant voltage source 17 sets a potential of node W1 to potential V1 which is a constant potential. NPN transistor 18 has a collector connected to a node W3 via resistance 14A, an emitter connected to node W2, and a base connected to PWM circuit 19. PWM circuit 19 applies a driving voltage having a modulated pulse width to the base of NPN transistor 18.

Light emitting apparatus 10B is also different from light emitting apparatus 10 in that a cathode of light emitting diode 12 is connected to node W3, an anode of light emitting diode 13 is connected to node W1, and a cathode of light emitting diode 13 is connected to one end portion of resistance 15. Since constructions of the other portions of light emitting apparatus 10B are similar to those of corresponding portions of light emitting apparatus 10, descriptions thereof will not be-repeated.

FIG. 7 is a diagram for describing variations with time in currents If1 and If2 shown in FIG. 6. Referring to FIG. 7, while current If1 is a pulse current, current If2 is a constant current (a DC current). Current 1f2 is set as a constant current to decrease adjustment operations. In the third embodiment as such, only current If1 is varied, and thereby a number of driving circuits included in light emitting apparatus 10B can be decreased.

When chromaticity is initially adjusted in light emitting apparatus 10B, a resistance value of resistance 14A is first varied to vary current If1. As current If1 increases, an oscillation peak wavelength of green light having a large wavelength variation varies from a long wavelength side to a short wavelength side to gradually change chromaticity obtained by mixing with blue light having a small wavelength variation. When desired chromaticity is obtained, current If1 is fixed. Current 112 flowing through light emitting diode 13 is adjusted to further make white light generated in light emitting apparatus 10B closer to a desired white color. Since a resistance value of resistance 15 is fixed in finished goods, chromaticity is adjusted by adjusting the resistance value of resistance 14A.

Intensity of emitted light is adjusted by adjusting a pulse width of a driving voltage applied from PWM circuit 19 to control a lighting time of light emitting diode 12.

As described above, according to the third embodiment, the light emitting diode emitting light of two colors is driven with a pulse current while the light emitting diode emitting light of one color is driven with a constant current to enable generation of white light with one driving circuit. Therefore, size and cost reductions of the light emitting apparatus can be attained.

It is to be noted that, though light emitting diode 12 is described as one light emitting device in each of first to third embodiments, a blue light emitting diode and a green light emitting diode connected to each other in parallel or in series may be used in place of light emitting diode 12. The green light emitting diode, however, should have a variation amount of an oscillation peak wavelength for a current amount larger than that of the blue light emitting diode. Though a circuit area becomes larger in this situation as compared to that in each of first to third embodiments, an effect of a cost reduction can be obtained because the blue and green light emitting diodes are generally inexpensive.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A light emitting apparatus generating white light by mixing a plurality of light, comprising:
a first light emitting device portion emitting first light having first and second oscillation peak wavelengths corresponding to a first driving current;
a second light emitting device portion emitting second light having a third oscillation peak wavelength and having a complementary color of a color of said first light corresponding to a second driving current different from said first driving current; and
a driving portion supplying said first and second driving currents to said first and second light emitting device portions, respectively.

2. The light emitting apparatus according to claim 1, wherein
said driving portion alternately outputs said first driving current and said second driving current.

3. The light emitting apparatus according to claim 2, wherein
a variation in said second oscillation peak wavelength is larger than that in said first oscillation peak wavelength when a value of said first driving current varies.

4. The light emitting apparatus according to claim. 3, wherein
said first oscillation peak wavelength is within a range of blue light,
said second oscillation peak wavelength is within a range of green light, and
said third oscillation peak wavelength is within a range of red light.

5. The light emitting apparatus according to claim 4, wherein
each of said first and second light emitting device portions is a light emitting diode connected in parallel between first and second nodes so as to have an electrical polarity opposite to each other, and
said driving portion applies an AC current having periodically changing polarities between the first and second nodes.

6. The light emitting apparatus according to claim 5, wherein
each of said first driving current and said second driving current has a waveform of a rectangular wave.

7. The light emitting apparatus according to claim 6, wherein
each of a period for flowing said first driving current and a period for flowing said second driving current is determined corresponding to chromaticity of said white light.

8. The light emitting apparatus according to claim 5, wherein
said AC current has a frequency from 30 Hz to 100 kHz.

9. The light emitting apparatus according to claim 1, wherein
said driving portion outputs a pulse current as said first driving current and outputs a constant current as said second driving current.

10. The light emitting apparatus according to claim 9, wherein
a variation in said second oscillation peak wavelength is larger than that in said first oscillation peak wavelength when a value of said pulse current varies.

11. The light emitting apparatus according to claim 10, wherein
said first oscillation peak wavelength is within a range of blue light,
said second oscillation peak wavelength is within a range of green light, and
said third oscillation peak wavelength is within a range of red light.
